(19) United States
(12) Patent Application Publication
(10) Pub. No.: US 2007/0195990 A1
(43) Pub. Date: Aug. 23, 2007

(54) Vision-Based Seat Belt Detection System

(76) Inventor: Uri Levy, Toronto (CA)

Correspondence Address: MAGNA INTERNATIONAL, INC., 337 MAGNA DRIVE, AURORA, ON, L4G-7K1, US

(21) Appl. No.: 11/675,101

(22) Filed: Feb. 15, 2007

Related U.S. Application Data
(60) Provisional application No. 60/774,118, filed on Feb. 16, 2006.

(51) Int. Cl. G06K 9/00; B60Q 1/00

(52) U.S. Cl. 382/100; 340/457.1

(57) ABSTRACT

The invention is a system and method that detects seat belt-related features using an image sensor. Reflective materials are optionally applied onto or embedded into the seat belt webbing, buckle, nest and handle to reflect patterns from infrared illumination to the image sensor. Software compounds these findings to result an overall ‘Belted’ and ‘Unbelted’ detection output. A temporal model software assists in stabilizing the decision in unsure situations by adding past images' decisions into the current decision. ‘Twisted belt’ and ‘Seat belt buckled behind back/seat’ situations can be also detected to notify the driver about unsafe occupant situations in the vehicle. The detection is applicable to safety belt detection for the driver seat, front passenger seat, back or any additional seats in vehicles.

This application claims the benefits of U.S. Provisional Application No. 60/774,118.

### FIELD OF THE INVENTION

The present invention relates to vehicle seat belts. More specifically, the present invention provides a camera system and method that determines whether the seat belts in the vehicle are belted or unbelted.

### BACKGROUND OF THE INVENTION

Seat belt systems and seat belt buckle tactile sensors exist are standard in every vehicle. Tactile sensors are reliable and low cost. However, they are limited in that the safety system generally does not know if a passenger is sitting in a seat that is unbuckled. Obviously, an empty seat with an unbuckled belt should not set off a warning signal, whereas a seat with a child and an unbuckled belt should.

Some auto manufactures have begun to provide vision camera systems into vehicles for applications such as driver alertness monitoring, passenger seat occupant classification or to detect children accidentally left in the rear passenger seats. While cameras can be used to view the seating area, it remains desirable to develop a simple and inexpensive method of visually determining whether a seat belt is buckled. In particular, it remains desirable to develop detection software which can reliably interpret the visual data provided by a camera in a computationally-efficient manner.

### SUMMARY OF THE INVENTION

It is an object of the invention to provide a seat belt detection system for a vehicle. According to a first aspect of the invention, there is provided a system includes a seat belt assembly, having a plurality of indicators distributed over predetermined portions of the seat belt assembly. An image sensor is located within the vehicle as to be able to receive an image of at least a portion of the seat belt assembly. An image processor is provided to analyze the image to identify said plurality of indicators for image analysis. The image analysis matches the identified plurality of indicators to a predefined set of indicators that characterize at least one particular status for the seat belt assembly.

According to a second aspect of the invention, there is provided a method for determining whether a seat belt assembly is buckled, the seat belt assembly having a plurality of indicators distributed over predetermined portions of the seat belt assembly using image recognition. The method includes the steps of illuminating at least a portion of the seat belt assembly; receiving a reflected image from at least a portion of the seat belt assembly; identifying at least one of the plurality of indicators from the reflected image; and comparing the identified at least one of the plurality of indicators to a predefined set of indicators that characterizes at least one particular status of the seat belt assembly.

### BRIEF DESCRIPTION OF THE DRAWINGS

Preferred embodiments of the present invention will now be described, by way of example only, with reference to the attached Figures, wherein:

FIG. 1 is a schematic view of a seat belt detection system in accordance with a first aspect of the invention;

FIGS. 2a to 2c are all front plan view of a portion of a different seat belt that can be used in the seat belt detection system shown in FIG. 1;

FIG. 3 a is a decision table using two detectors and tri-state logic for determining the state of the seat belt detection system shown in FIG. 1;

FIG. 3b is a decision table using two detectors and binary logic for determining the state of the seat belt detection system shown in FIG. 1;

FIG. 4 is a decision table using three detectors and tri-state logic for determining the state of the seat belt detection system shown in FIG. 1;

FIG. 5 is a decision table using three detectors and tri-state logic for determining the state of failure for the seat belt detection system shown in FIG. 1;

FIG. 6 is a flow chart for determining the state for the seat belt detection system shown in FIG. 1, in accordance with another embodiment of the invention; and

FIG. 7 is a table showing different possible scat belt states in accordance with the flow chart shown in FIG. 6.

### DETAILED DESCRIPTION OF THE INVENTION

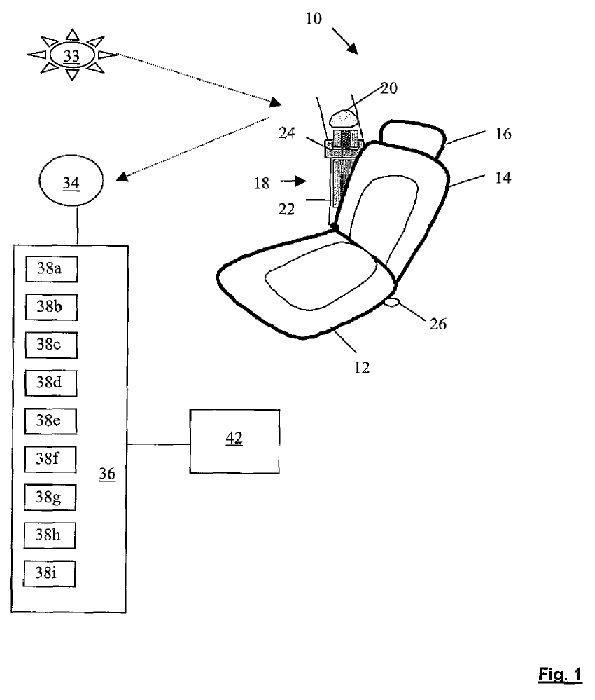

Referring now to FIG. 1, a vehicle seat is shown generally at 10. Seat 10 includes a lower cushion 12, an upper cushion 14, and a head support 16. A three-point seat belt assembly 18 is provided to safely secure a passenger. While only one seat 10 and seat belt assembly 18 is shown, it is contemplated that all seats and seat belts in the vehicle are substantially the same. Seat belt assembly 18 includes a nest 20 (which spools the seat belt when not in use), a web 22, a seat belt handle 24 (having a latching plate), and a seat belt buckle 26. When buckled, seat belt handle 24 is latched into seat belt buckle 26, and when unbuckled, web 22 retracts into nest 20, moving seat belt handle 24 adjacent to nest 20. This is often referred to as the “nested” position. Preferably, seat belt buckle 26 includes a conventional tactile sensor 27 which outputs whether or not seat belt handle 24 is latched into buckle 27. However, seat belt buckles 26 without tactile sensors are within the scope of the invention.

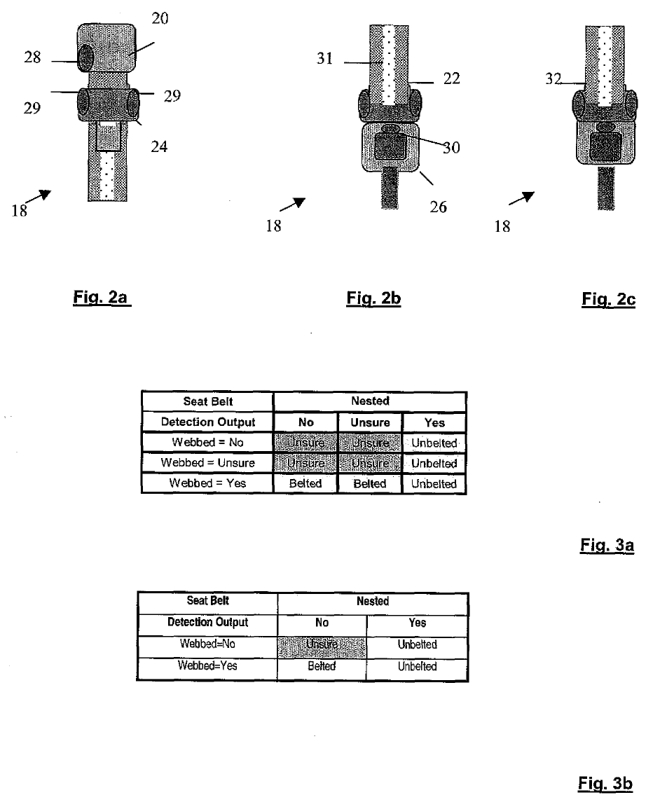

Referring now to FIGS. 2A to 2C, seat belt assembly 18 is described in greater detail. Seat belt assembly 18 includes a plurality of strategically patterned indicators that are used to improve the accuracy for image recognition. The indicators are known portions of seat belt assembly 18 that are provided with reflective portions. Preferably, the reflective portions reflect only within an invisible portion of the light spectrum as to be unnoticeable to the passenger. FIG. 2A shows an infrared reflective material 28 embedded on the surfaces of nest 20 and reflective material 29 on the surface of seat belt handle 24. Preferably, reflective material 29 is embedded on opposing edges of seat belt handle 24. Using two reflective regions improves image recognition, and is described in greater detail below. A reflective material 30 is provided on the surface of seat belt buckle 26. FIGS. 2B and 2C show two different reflective patterns being provided on a portion of web 22, namely inside pattern 31 and outside pattern 32. As is described in greater detail below, the use of differing inside patterns 31 and outside patterns 32 assists in detecting when the seat belt web is twisted. The patterns and locations of reflective materials on seat belt assembly 18 are not particularly limited, and could be patterned and positioned differently from the ones shown in FIGS. 2A to 2C without departing from the spirit of the invention. For example, a web 22 may include only a single reflective pattern.

Referring back to FIG. 1, an infrared illumination source 33 emits light into the vehicle cabin that is invisible to the human eye but is reflected by infrared reflective materials 28, 29, 30 and patterns 31 and 32. An image sensor 34 is also provided somewhere in the vehicle that normally has a line of sight to seat belt assembly 18 (barring obstructions). Image sensor 34 is operable to capture light reflected by reflective materials 28, 29, 30, 31 and 32 (which is normally captured in grayscale). Typically, image sensor 34 is a monocular digital image sensor, and can be a 2D image sensor (e.g. CMOS) or a 3D image sensor (e.g. Time of Flight technology) or other single digital sensor. Raw image files are transmitted from image sensor 34 to an image processor 36.

Image processor 36 can apply known image-processing techniques to the captured image. For example, it can decompose edges from the captured image using known edge filters; and then apply feature-matching software (described in greater detail below) to predetermined edge features of the various indicators. Image process 36 could also decompose wavelet coefficients from the captured image using known wavelet filters. The feature matching software would then multiply a wavelet decomposed vector of coefficients from the image with predefined wavelet-based operator vectors. The predefined wavelet-based operator vectors could be generated from pre-trained videos of seat belt related features and usage situations. These techniques are preferably applied by software running on image processor 36, but could also be implemented using firmware or hardware within the processor. The implementation of image processor 36 is not particularly limited, and can include a general microcontroller or a digital signal processor, along with memory storage.

Image processor 36 operates a plurality of software detectors 38 that are each operable to detect specific features (described in greater detail below) from the captured image, and generate a logical output. For image processors 36 that use binary logic, the possible outputs from each software detector 38 are “YES” or “NO”, and for image processors 46 that are capable of tri-state logic, the possible outputs can typically be defined as “YES”, “NO” or “UNSURE”. Each software detector 38 works on a region of interest within the image and detects its task. Preferably, image processor uses the following detectors 36. For the following scenario, tri-state logic is used:

Detector 38a, “Seat belt nest is seen!” returns whether reflective material 28 on seat belt nest 20 is seen or not. This indication is important for next detector's function. When detector 38a detects seat belt nest 20, detector 38b, “Seat belt handle is nested or close to nest?” determines whether seat belt handle 24 is located proximate nest 20 by recognizing reflective material 29 on seat belt handle 24. When seat belt handle 24 is in the nested position, it can often be occluded by the occupant's head or body. In this case, the output of detector 38b would be “UNSURE”. Also, in many vehicles, the seat belt nest 20 can slide up and down along web 22 to adjust for larger occupants. Recognizing the next position of seat belt handle 24 by itself could provide an indication for the adult class or for a large adult occupant indication.

Detector 38c, “Seat belt buckle is seen?” determines whether reflective material 30 on seat belt buckle 26 is seen or not. This indication is important for next detector's function. When detector 38c detects the seat belt buckle, detector 38d, “Seat belt handle is buckled or close to buckle?” determines whether seat belt handle 24 is in its buckled position, otherwise it returns “UNSURE”. In certain vehicles, buckle 26 is clearly visible and in others it is almost always hidden by an armrest located between the passenger and the driver seats. In the latter case, detectors 38d would not be used and hence the seat belt detection reliability would be reduced.

Detector 38e, “Seat belt web is seen?” determines whether either inside pattern 31 or outside pattern 32 on web 22 is visible. This indication is important for next detectors' function. When detector 38e detects web 22, detector 38f, “Seat belt web is retracted at the nest?” determines whether the detected patterns 31 and/or 32 are found in the retracted position adjacent nest 20 only, or also over an occupant or seat locations.

When detector 38e detects web 22, detector 38g, “Seat belt web is webbed?” determines whether seat belt assembly 18 is webbed over an occupant or an object on the seat or on the seat itself. The seat belt web 22 could often be hidden by the occupant's arms, clothes, blanket, and accessories and if cannot be seen, detector 38g outputs a result of “UNSURE”. When detector 38e detects web 22, detector 38h, “Seat belt web is twisted (once or more)?” determines whether inside pattern 31 and outside pattern 32 on web 22 match a predefined regular web pattern, which indicates that web 22 is untwisted. If inside pattern 31 and outside pattern 32 do not match a predefined regular web pattern, then web 22 is twisted. If more than one switch between these patterns 31 and 32 is detected, then detector 38e outputs a result of “Twisted more than once”. These results can be used to notify the driver that an unsafe situation occurred in the vehicle. When detector 38e detects the seat belt web, detector 38i, “Seat belt web is behind occupant's or seat's back?” determines whether a portion of inside pattern 31 and outside pattern 32 are interrupted which could indicate an occupant occluding web 22 behind his or her back, hence creating an unsafe seat belt condition. This result could be used to notify the driver that an unsafe situation occurred in the vehicle.

The outputs from multiple software detectors 38 (along with any outputs from tactile sensors 27) are transmitted to a safety processor 42 that then determines the current state of seat belt assembly 18, and provide warning indicators to the driver. While the present illustration shows safety process 42 as a separate controller, it could share the same hardware as image processor 36. Safety processor 42 identifies the state of seat belt assembly 18 by comparing the outputs from software detectors 38 to a matrix of different outputs. FIG. 3 a provides a sample decision table listing all possible safety states for seat belt systems where the buckle is not visible, or that lacks a tactile sensor 27. Seat belt states include “BELTED”, “UNBELTED” and “UNSURE”. An UNSURE state indicates that safety processor 42 is unable to determine the current state of seat belt assembly 18 from the current frame. In this example, the determination of the state of seat belt assembly 18 is based on two detectors indications only, 38e and 38b. 38b, “Seat belt handle is nested” appear in the columns of the table; and 38e, “Seat belt web is webbed”—appear in the rows of the table. Using tri-state logic, the two detectors can produce 9 output possibilities as depicted in the table. In bi-state mode logic the two detectors can produce 4 outputs only (FIG. 3b). For bi-state detectors the Nested/Unsure column and Webbed/Unsure line are be omitted so that there remain four indication possibilities. Out of these 4 possibilities there is a situation of ‘Nested=No’ and ‘Webbed=No’ that returns the overall decision of “UNSURE”. Using only these two detectors may not provide the granularity and overall reliability that one may get using more detectors.

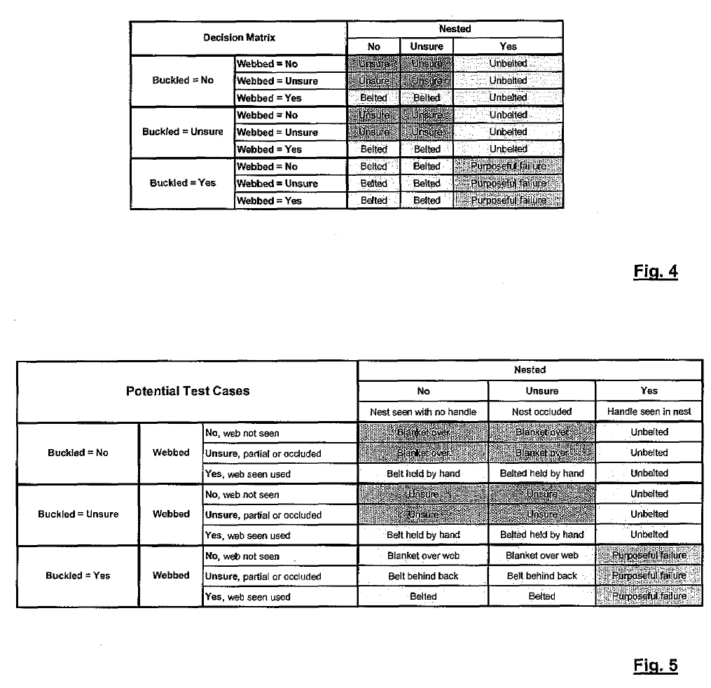

FIG. 4 provides a sample decision table using tri-state logic to list all possible safety states for seat belt systems that includes either buckle recognition or a tactile sensor 27. In this example, detectors 38b, 38c and 38e are used. Seat belt states include “BELTED”, “UNBELTED”, “UNSURE”, and “PURPOSEFUL FAILURE”. An UNSURE state indicates that safety processor 42 is unable to determine the current state of seat belt assembly 18, and PURPOSEFUL FAILURE indicates that a user has clearly overridden the seat belt feature. Using three detectors will lead to a higher reliability level than the previous case described in FIG. 3. For bi-state detectors the ‘Nested=Unsure’ column, the ‘Webbed=Unsure’ row, and the ‘Buckled=Unsure’ stripe shall be omitted so that there remain two by two by two indication possibilities. Out of these 8 possibilities there are situations that return the overall decision of “UNSURE”.

FIG. 5 provides a sample failure mode analysis table listing different failure cases based upon real-life usage scenarios. The structure of this table is identical to the one in FIG. 4, but in each cell real life examples are provided to illustrate the reason for the failure. For example, the detector ‘Seat belt is nested’ returns a “NO” if the nest is seen without the handle near it; or the detector ‘Seat belt web is webbed’ returns “UNSURE” if the web is partially occluded. The real life situation related to these two detectors could be if a blanket is put over the occupant so that the seat belt web is hardly seen. The other real life cases could be understood from the table in a similar fashion.

The detectors described above show the structure and logic of the decision but they can also vary and be structured differently to provide the seat belt detection.

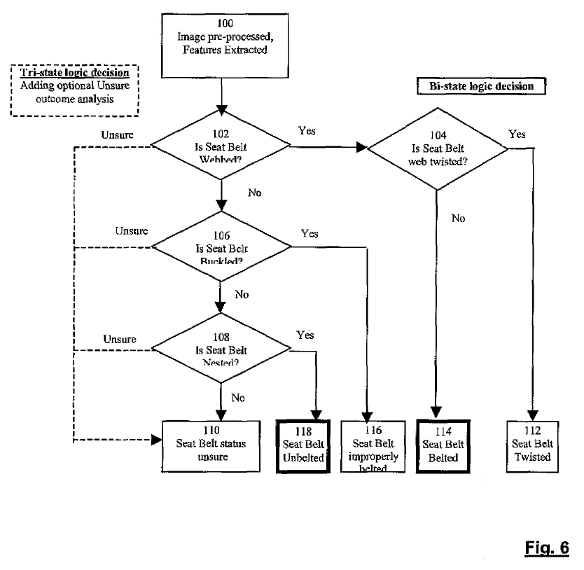

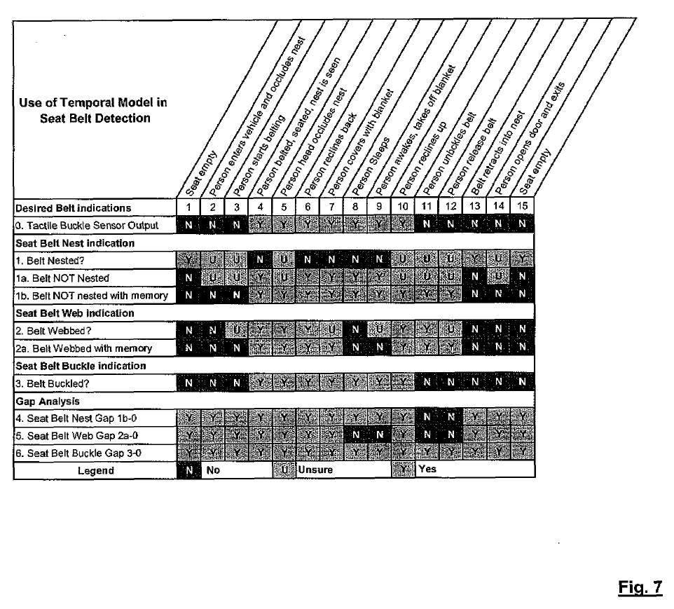

Referring now to FIGS. 6 and 7, a second embodiment of the invention is shown that uses a temporal model to improve state determination when the current seat belt status is currently “UNSURE”. With a temporal model, safety processor 42 uses previously detected information to assist detection at present time. FIG. 6 shows a simple flow chart for an example method using both binary and tri-state logical outputs. The bi-state logic is depicted in solid lines and the optional tri-state logic which handles “UNSURE” outputs is added in dashed lines. The example provided here does not limit the method of seat belt detection that could be detected by different decision flow charts.

Beginning at step 100, an image processor 36 receives an image from image sensor 34. Image processor 36 executes the various detectors 38, as described above, and passes those logical outputs to safety processor 42.

At step 102, safety processor 42 determines whether the seat belt webbing 22 is detected, based upon the outputs of detector 38e. If yes, the method advances to step 104. If no, the method advances to step 106. If at any time, the result is indeterminate, the method advances to step 110.

At step 104, safety processor 42 evaluates whether the seat belt webbing 22 is twisted, based upon the outputs of detector 38h. If yes, then the method advances to step 112, where the determination is that the seat belt assembly 18 is twisted. If no, then the method advances to step 114, where the determination is that the seat belt is properly belted.

At step 106, safety processor 42 evaluates whether seat belt assembly 18 is buckled based upon the outputs of detector 38d. If yes, then the method advances to step 116 where the determination is seat belt is improperly belted. If no, then the method advances to step 108.

At step 108, safety processor 42 evaluates whether seat belt assembly 18 is nested based upon the output of 38b. If yes, then the method advances to step 118, where the determination is that seat belt assembly 18 is unbelted. If no, then the method advances to step 110, where determination is that the status of seat belt assembly 18 is “UNSURE”.

At step 110, safety processor 110 is unsure of the current seat belt state. It recalls the logical outputs from a previous frame for interpretation. The temporal model in seat belt detection takes advantage from belt indications detected in previous frames and applies a few simple memory latching, reset and Boolean operations that keep track of detection outputs even when those cannot be directly deduced from the current image. While image sensor 34 is capable of recording multiple frames per second, safety processor 42 would not save every previous image frame per second in order to conserve memory. Presently, safety processor 42 latches an image frame whenever an output from one of the indicators 38 is “UNSURE”.

FIG. 7 shows over an example 15 steps scenario. The temporal model works by using previous definite decisions to override currently detected “UNSURE” detector results. This scenario shows a common usage pattern for seat belt assembly 18, and could be used as part of the logic that decides the overall seatbelt detection output based on current captured frame by the camera.

The top row of the table lists fifteen steps that an occupant could go through in a typical sitting scenario. Step 1 starts when seat 10 is empty, step 2 is when a person enters the vehicle and occludes nest 20. Subsequent steps show what the person does in the vehicle that may or may not obscure the different detectors on seat belt assembly 18, until in step 14 the person opens the door and exits the vehicle, and in step 15 seat 10 is empty again. The state of certain detectors can be reliably predicted for each step in this usage scenario. For example, at step 1 (when seat 10 is empty), nest 20 will almost certainly be visible to image sensor 34, given its relatively high position in the vehicle. When a person enters the vehicle, but is not yet properly seated (step 2), seat belt nest 20 will likely be occluded.

Within the table, the left column lists the seat belt detectors that return outputs on the seat belt status in each one of the 15 steps provided in the example scenario:

Row 0 indicates whether buckle 26 has latched a handle 24 based upon the output of tactile sensor 27 (on buckle 26). Possible outputs are YES or NO. As is described above, not all seat belt buckle 26s need to include a tactile sensor 27.

Rows 1, 1a, and 1b deal with whether or not seat belt nest 20 can be seen. As described above, detector 38a outputs a result of YES, NO or UNSURE based on image analysis. Row 1 shows what an ideal image-based response for detector 38b, “Belt nested” would return at each step in the scenario. Row 1a shows what a NOT function applied to the results of row 1 (i.e., detector 38b output) for each step in the scenario. Row 1b shows what a MEMORY function over Row 1a returns per each step in the scenario by converting UNSURE states to the previous known state. For example, in step 4 (“Person belted, seated, and nest is seen”), row 1 would be NO since seat belt assembly 18 is not nested, and row 1 a would be YES since a NOT operand is applied to the results of row 1. Since the output of Row 1a is not UNSURE, row 1b does not change the output value.

Rows 2 and 2a deal with whether or not the seat belt buckle can be seen. As described above, detector 38a outputs a result of YES, NO or UNSURE based on its visual analysis. Row 2 shows what the ideal image-based response for detector 38b, “Seat belt webbed” would return for each step in the scenario. Row 2a shows what MEMORY function over row 2 returns per each step in the scenario by converting UNSURE states to the previous known state.

Row 3 shows what the ideal image-based response for detector 38d, “Seat belt buckled” would return for each step in the scenario. The outputs for detector 38d should correspond to the outputs from tactile sensor 27 (if present), as indicated in row 0.

FIG. 7 also illustrates a gap analysis between the vision system detectors and the traditional seat belt tactile sensor in the buckle in line 0. Each line in the gap analysis compares the results of image-based detector indicator and the tactile sensor 27. Row 4 shows the gap analysis between rows 1b and 0, between image-based detector 38b (“Seat belt nested”) and tactile sensor 27 (“Seat belt buckled”) so that all identical results show “YES” and others have “NO”. Row 5 shows the gap analysis between rows 2a and 0, between image-based detector 38g (“Seat belt webbed”) and tactile sensor 27 so that all identical results show “YES” and others have “NO”. Row 6 shows the gap analysis between rows 3 and 0, between image-based detector 38d (“Seat belt buckled”) and tactile sensor 27 so that all identical results show “YES” and others have “NO”.

While the embodiments discussed herein are directed specific embodiments of the invention, it will be understood that combinations, sub-stets and variations of the embodiments of the invention are within the scope of the invention which is defined solely by the claims.

What is claimed is:

1. A seat belt detection system for a vehicle, comprising:
a seat belt assembly, having a plurality of indicators distributed over predetermined portions of the seat belt assembly;
an image sensor, located within the vehicle as to be able to receive an image of at least a portion of the seat belt assembly;
an image processor, operable to analyze the image to identify said plurality of indicators for image analysis; the image analysis matching the identified plurality of indicators to a predefined set of indicators that characterize at least one particular status for the seat belt assembly.

2. The seat belt detection system of claim 1, wherein the seat belt assembly includes:
a seat belt nest, having a webbing extending from the seat belt nest;
a seat belt handle movably mounted to the webbing, the seat belt handle having a latching plate; and
a buckle, mounted to a vehicle seat and operable to receive the latching plate from the seat belt handle.

3. The seat belt detection system of claim 2, further comprising:
an infrared light source that illuminates the seat belt assembly; and wherein the plurality of indicators distributed over the seat belt assembly are operable to reflect the infrared light source to the image sensor, and the image sensor is operable to receive the reflected infrared light from the plurality of indicators.

4. The seat belt detection system of claim 3, wherein the image processor is operable to characterize a seat belt status as “Belted” or “Unbelted” based upon the interpretation of at least one of the plurality of indicators.

5. The seat belt detector system of claim 4, wherein the plurality of indicators includes at least one of a nest indicator, an outer web indicator, an inner web indicator, a seat belt handle indicator, and a buckle indicator.

6. The seat belt detector system of claim 5, wherein the particular status indicator includes at least one of a “Seat belt nest is seen” indicator, a “Seat belt handle is nested” indicator, a “Seat belt buckle is seen” indicator, a “Seat belt handle is buckled” indicator, a “Seat belt web is seen” indicator, a “Seat belt web is webbed” indicator, a “Seat belt web is twisted” indicator, and a “Seat belt web is behind occupant's back” indicator.

7. The seat belt detector system of claim 6, wherein the particular status is defined as one of a pair of opposing binary conditions.

8. The seat belt detection system of claim 7, wherein the particular status is further defined as one of a pair of opposing binary conditions or an “Unsure” condition if the image processor is unable to recognize a particular indicator.

9. The seat belt detector system of claim 7, wherein the seat belt assembly is characterized as “Belted” or “Unbelted” based upon comparing at least two particular status indicators to a predefined set of indicators that characterize the seat belt assembly as “Belted” or “Unbelted”.

10. The seat belt detector system of claim 8, wherein the image processor is operable to store a previously-recorded image of the seat belt assembly, and use the previously-recorded image of the seat belt assembly to characterize a particular status that is currently defined as “Unsure”.

11. The seat belt detection system of claim 9, wherein the image sensor is operable to receive an image of at least a portion of multiple seat belt assemblies from at least two vehicle seats.

12. The seat belt detection system of claim 11, wherein the at least two vehicle seats includes a rear passenger seat.

13. The seat belt detection system of claim 12, wherein the image sensor installed in a roof console within the vehicle.

14. The seat belt detection system of claim 12, wherein the image sensor installed in a vehicle pillar.

15. A method for determining whether a seat belt assembly is buckled, the seat belt assembly having a plurality of indicators distributed over predetermined portions of the seat belt assembly using image recognition, the method comprising:
illuminating at least a portion of the seat belt assembly using a light source;
receiving a reflected image from at least a portion of the seat belt assembly at an image sensor;
identifying at least one of the plurality of indicators from the reflected image using an image processor; and
comparing the identified at least one of the plurality of indicators to a predefined set of indicators that characterizes at least one particular status of the seat belt assembly.

16. The method of claim 15, wherein the plurality of indicators includes an indicator on a seat belt handle and an indicator on a seat belt nest, and where characterizing the at least one particular status of the seat belt assembly includes a nested status one of “Nested” and “Not Nested”.

17. The method of claim 16, wherein the plurality of indicators further includes an indicator on a seat belt buckle, and where characterizing the at least one particular status of the seat belt assembly includes a buckled status one of “Buckled” and “Not Buckled”.

18. The method of claim 17, wherein the plurality of indicators further includes an indicator on a seat belt webbing, and where characterizing the at least one particular status of the seat belt assembly includes a web status one of “Webbed” and “Not Webbed”.

19. The method of claim 17, wherein identifying the indicator on the seat belt handle proximate to the indicator on the seat belt buckle characterizes the buckled status of the seat belt assembly as “Buckled”, and where identifying the indicator on the seat belt handle displaced away from the indicator on the seat belt buckle by a predetermined distance characterizes the buckled status of the seat belt assembly as “Not Buckled”.

20. The method of claim 19, wherein a belted status of the seat belt assembly is characterized as “Belted” if it is currently characterized as “Buckled” and “Webbed”, and is otherwise characterized as “Unbelted”.

21. The method of claim 17, wherein characterizing the particular status of the seat belt assembly includes a twisted web status one of “Twisted web” and “Not twisted web”.

22. The method of claim 19, wherein when the seat belt assembly is characterized as “Buckled” and also “Not webbed”, the seat belt assembly is further characterized as being “improperly belted”.

23. The method of claim 22, wherein the seat belt assembly is characterized as “Belted” or “Unbelted” based upon comparing the nested status, the buckled status and the webbed status to a predefined set of indicators.

24. The method of claim 15, wherein at least one particular status of the seat belt assembly can be characterized as “Unsure” when at least one of the plurality of indicators is not reflected back into the image sensor.

25. The method of claim 24, further comprising:
recalling a previously-recorded image of the seat belt assembly from memory and using the previously-recorded image of the seat belt assembly to characterize a particular status that is currently defined as “Unsure”.

26. The method of claim 15, wherein the plurality of indicators use an infrared reflective material, and where the light source illuminating the at least a portion of the seat belt assembly uses an infrared light source.

27. The method of claim 26, wherein identifying the at least one of the plurality of indicators by the image processor includes using edge filters on the reflected image, and where the predefined set of indicators used for comparison includes a predefined set of edge features to be compared against.

28. The method of claim 26, wherein identifying the at least one of the plurality of indicators by the image processor includes decomposing wavelet coefficients from the reflected image using known wavelet filters, and where the predefined set of indicators used for comparison includes predefined wavelet-based feature vectors generated from videos of the seat belt assembly.
